(19) United States
(12) Patent Application Publication
(10) Pub. No.: US 2009/0106456 A1
(43) Pub. Date: Apr. 23, 2009

(54) Method and apparatus for interactions of web applications with the local host environment

(76) Inventors: Urs Muller, Morganville, NJ (US); Paula Muller, Morganville, NJ (US)

Correspondence Address: Gearhart Law, LLC, 4 Ferndale Rd, Chatham, NJ, 07928, US

(21) Appl. No.: 11/975,505

(22) Filed: Oct. 19, 2007

(51) Int. Cl. G06F 3/01; G06F 3/00

(52) U.S. Cl. 710/5; 710/61

(57) ABSTRACT

The invention provides a method and apparatus for providing an access layer for web-based applications to access at least one resource of a local host. The interface is removed from the application code and the application code exchanges data with the access layer to access the local resources of the local host. Among other things, the invention allows web-based applications to interact with the local file system, to allow end users to browse directory trees of internal or external storage devices, and to work offline.

### BACKGROUND OF THE INVENTION

Web applications have become increasingly popular in recent years because they are easy to use, let the service provider control the user interface, are platform independent., require no client side software installation, and can be made to work on mobile and hand held devices.

The prior art solutions have two main limitations: 1) their interaction with resources or software of the local host environment is limited, and 2) they do not work when the user is off-line, e.g., in the airplane or in the subway. For example, prior art solutions can exchange files between the local PC disk and the network only on a per file basis. Users are limited to downloading one file at a time. While users can upload multiple files, each file has to be selected individually. To upload or download entire directory trees, users must convert such trees into a single file first, e.g., by embedding them in a ZIP or TAR file. This is inconvenient at best and not supported by most web applications.

Over the years, software vendors have created and promoted a number of technologies to overcome these limitations, including client-side execution of applications by utilizing technology such as ActiveX and Flash as two examples. However, such technologies require client side software installation and are therefore not device, platform, and operating system independent. Platform independent programs thus need to be fairly simple in design, compared to their platform specific counterparts.

Today, platform-independent programs are achieving greater complexity and interoperability with the use of technologies which have become widespread: Cascading Style Sheets (CSS), Javascript, the Document Object Model (DOM), and the JavaScript XMLHttpRequest object. The combined use of these three technologies has recently become known under the term “Ajax” which stands for Asynchronous JavaScript and XML.

The original purpose of CSS was to separate content from style in web pages. The use of CSS lets web designers define font size, style, color, and background color, of titles, subtitles, body text, and so on, in a separate file which can be shared among many web pages. This makes it easy to apply a consistent style throughout a web site, update the style in a single place for an entire web site, and maintain different styles for different web browsers (e.g., one style for PCs and another for hand held devices). In addition to separating style from content, CSS also greatly increases the amount of control a web application has over style and appearance compared to HTML and XHTML.

The basic CSS element is a rectangular box which can either be placed automatically by the web browser or whose exact position on the screen can be defined in the CSS code. The CSS can further control the background color, text attributes, frame type, color, and visibility of the box.

JavaScript (or ECMA Script) is a scripting language which is interpreted by the browser. It was introduced by Netscape to overcome some of the static limitations of web pages and has become a standard browser feature. Its typical early use was for form checking.

The Document Object Model (DOM) is a standardized interface between JavaScript and the objects on a web page. It allows JavaScript to change the style of existing web page objects, to create new objects and remove objects, all without loading a new page. By combining the use of CSS, JavaScript, and DOM, flexibility abounds. For example, a context menu can be implemented by drawing a number of boxes, stacking the boxes vertically, and causing the boxes to appear at the mouse pointer location when the user clicks the right mouse button. If used with handler functions in JavaScript, the process can be automatically called by the browser when mouse buttons are pressed or when the mouse moves. These same techniques can also be used to implement drop-down menus, and drag-and-drop.

These UI elements have existed in applications and operating systems residing on a host computer in a specific platform. However, in Ajax implementations, UI development has become platform- and device-independent. FIG. 4 shows the screen shot of a browser user interface with drop-down menu.

The XMLHttpRequest object can be used by JavaScript to send and receive information to and from a web server in the background. For example, when a user right-clicks on an object and selects “delete” from the context menu, JavaScript can issue a delete request in the background and subsequently remove the object from the HTML or XHTML page. The web server returns structured data formatted in XML which the XMLHttpRequest object parses and makes available to the JavaScript code in a structured object tree format. Once the application is running, no further web pages are loaded. Instead, the JavaScript code keeps modifying the originally loaded web page as needed to reflect changes in the repository and to interact with the user.

While Ajax has made a great leap forward in interoperability and cross-platform applications, such applications are still severely inhibited. There is only limited interaction with the local file system. Data can only be exchanged at the level of a single file. In typical web applications, multiple files must be selected and transferred individually. Further, web applications require the user to be online. This limits the availability of the application for users who travel. While network access is constantly proliferating to ever more locations, airplanes still remain an important exception. Traditional web applications cannot be used in airplanes.

Thus, there has been a long-felt and unsolved need to provide a solution to allow platform independent web based applications to interact with the local file system, other local resources and software, and to operate in off-line mode. Such a solution must overcome the prior art limitations of client software installation and platform-specific requirements, while still being able to interact directly with the local file system and work off-line.

### SUMMARY OF THE INVENTION

An embodiment of the invention provides a method for accessing a resource on a local host by executing an application in a web environment. The application exchanges data with a web server and an access layer. The access layer also exchanges data with the local host and provides hardware access to at least one resource on the local host. The access layer is configured for accessing at least one resource on a local host computer such as a file system, an attached storage device, a program running on the host computer, or a peripheral device. The file system may comprise repositories, directories, mail servers, and databases. User Interface templates are further provided so that the application may be efficiently used in a multitude of computing environments.

In an embodiment of the invention, an interface component is provided which comprises an access layer for access to at least one resource of a local host and application code is executed in a web browser allowing interaction with the at least one resource of the local host via the access layer.

In embodiments of the invention, the access to resources of the local host is by means of direct access or access through an abstraction layer. Further, the local host may be a personal computer, a personal digital assistant, or any other device capable of executing a web application.

In embodiments of the invention, the application may be executed when the local host is disconnected from a network. Further, data synchronization is triggered when the local host toggles from an offline to an online state.

### BRIEF DESCRIPTION OF THE DRAWINGS

FIG. 1 shows a block diagram of a platform independent configuration on which the present invention may be implemented.

FIG. 2 shows a block diagram of a platform independent method of implementing of an embodiment of the invention accessing a resource of the local host.

FIG. 3 shows a block diagram of an embodiment of the invention utilizing an access layer.

FIG. 4 shows a screenshot of a web-based application accessing a repository on a network with seamless integration of the local file system tree.

FIG. 5 shows a screenshot of a web-based application executed on a cellular phone, accessing a repository on a network and locally stored messages.

FIG. 6 shows a block diagram of a platform independent method of implementing an embodiment of the invention with an offline mode.

FIG. 7 shows a block diagram of a suitable computing environment in which the invention may be implemented.

### DETAILED DESCRIPTION

It should be appreciated that a typical software program is programmed to be executed on a unique hardware and software platform. For example, a first software program may require a CISC-based processor and Windows operating system, and a second software program may require a RISC-based processor and a Linux operating system. Further, a third software program may require direct interaction with a video display and fourth software program may require access to permanent storage such as a hard drive or network drive. Embodiments of the invention advantageously permit software developed for a multitude of hardware and operating system configurations even when the underlying hardware and operating systems are radically different.

This invention utilizes a web-based interface which is both vendor and client independent. The system and method of accessing data works without client software installation and may be executed on substantially any device with a network connection. The system and method may be used with a vast array of devices including computers, PDAs, smart phones, cellular phones, and the like. Further, embodiments of the invention function in an offline mode where the host computer is disconnected from the network.

An embodiment of the invention provides an access layer that permits web-based software to be developed in a hardware and operating system independent manner. The access layer resides in a layer in the software architecture between an application executed in a web browser and the operating system of the local host running the web browser. The access layer allows software that is developed for execution in one browser and one environment to be efficiently executed in another browser in another environment. Further, many applications can be developed initially to be cross-platform by utilizing the access layer of the invention. Use of the access layer promotes the rapid development and advancement of cross-platform software and hardware.

The APIs used in the present invention allow code to be expressed in terms of higher level functions. For example, a more convenient notation used by embodiments of the invention describes display of a drop down box rather than providing that when there is a mouse click in a particular area bounded by a rectangle that a series of lines are drawn in the shape of boxes below the position of the mouse in a precise order. By providing a function called “drop down box” which corresponds to at least the steps described above for drawing a drop down box, the code necessary to cause a drop down box to be drawn on various platforms is executed. Typically, to be cross platform this code is implemented in JavaScript and utilizes the DOM to carry out the instructions. In an embodiment of the invention, the access layer is configured to carry out the functions by accessing the likewise functions already existing on the browser and on the local host. Thus, by example, if the application is executed in a MacOS environment, a Macintosh browser and the MacOS API is used to provide the drop down box.

By contrast, when conventional applications are configured for a specific operating system and specific computing environment, such applications must be reconfigured for use in other environments. Such programming is often proprietary and does not translate well to other environments chaining the application to a particular platform and requiring outlays of manpower and money to adapt the application to other environments. For example, an image cataloging application may be configured to work directly with the ext2 file system and KDE environment. When the user changes to another environment, even in the same operating system such an ext3 file system and GNOME, completely different APIs are used making use of both libraries required. By programming the application using the interface component of the invention comprising the access layer for interaction with the resources such as the file system and video system of the operating system, the same application can be run in multiple environments without the need for the application to invoke multiple code libraries or APIs.

The cross-platform nature of the interface component allows a single API to be used in a variety of hardware and software environments. The interface component can be loaded on a variety of platforms in a variety of web browsers. For example, the illustrated interface component can be implemented on a broad variety of operating systems, such as Linux, Unix, Microsoft Windows MacOS and the like. A wide variety of computing devices can also host the resources to be accessed. For example, the computer devices can correspond to personal computers, to laptop computers, to personal digital assistants (PDAs), to cellular phones, to single-board computers, and the like. It should be understood that the interface component of the invention is developed in such a manner as to be capable of being run automatically within a web browser or on a server itself. Still further, the resources to be accessed by the application may be local or remote. Thus, a repository may be physically located on the computing device where the application is executed in the web browser or it may be at another location across a network such as a LAN or the internet.

Thus, the embodiments of the invention can provide at least one of the following benefits:
(I) provide a flexible framework for abstracting hardware devices;
(II) provide platform neutrality; and
(III) provide system-level efficiency for control of hardware resources.
   These and other benefits of the invention will be described in more detail herein below.

To achieve platform neutrality and system-level efficiency, an embodiment of the invention is implemented with the JavaScript programming language. The JavaScript programming language provides relatively widely standardized support on a variety of platforms with high efficiency. In addition, the JavaScript programming language's support of object oriented methodology also promotes a relatively well organized software design. It will be understood by one of ordinary skill in the art that a wide variety of programming languages can be used.

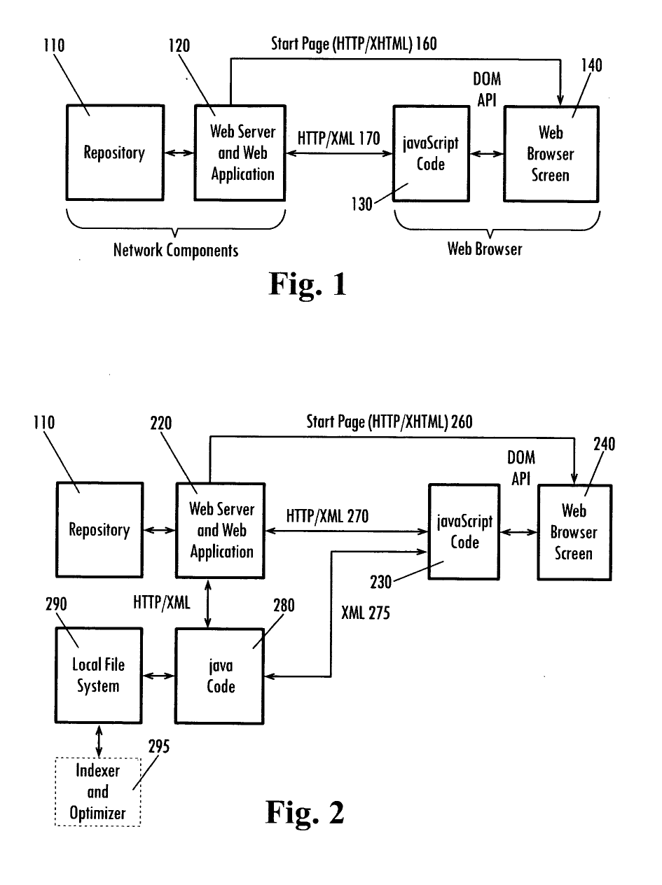

Referring now to FIG. 1, a typical method of implementing is shown using JavaScript. JavaScript code started from a webpage 160 runs as a standalone thread in the background. When data is exchanged in the background, the web browser screen typically is not updated as a result and the user has an uninterrupted experience with the user interface of an application. The background threads allow existing JavaScript code 130 to be fully reused for interactions with the local file system. The JavaScript code 130, and more specifically, the XMLHttpRequest object are used to exchange data with a web server 120 in the background. This exchange of data is typically accomplished with the HTTP protocol and the XML markup language 170.

The JavaScript code 130 controls the display of the web browser screen 140 of the web browser. The web server 120 further comprises a web application to access and manipulate data in a repository 110. For example, when a user right-clicks on an object and selects “delete” from the context menu, then JavaScript can issue a delete request in the background and subsequently remove the object from the HTML or XHTML page 160. This operation would otherwise require a reload of the entire page.

FIG. 2 shows a block diagram of a platform independent method of implementing an embodiment of the invention accessing a resource of the local host. In this embodiment, the numbered items correspond to the items in FIG. 1 but have been incremented by 100. The embodiment of FIG. 2 allows access to resources on a local host by using Java code 280 which exchanges data with a web server and web application 220. The web server and web application 220 reside on the network. Further, the Java code interacts with the local host via an XML interface 275 allowing JavaScript code 230 and the web application 220 to receive input and manipulate a local file system 290. In an embodiment of the invention, the local file system exchanges data with and interacts with an indexer and optimizer 295 which allows quicker access to the Local File System by providing indexed and optimized data to the web application 220.

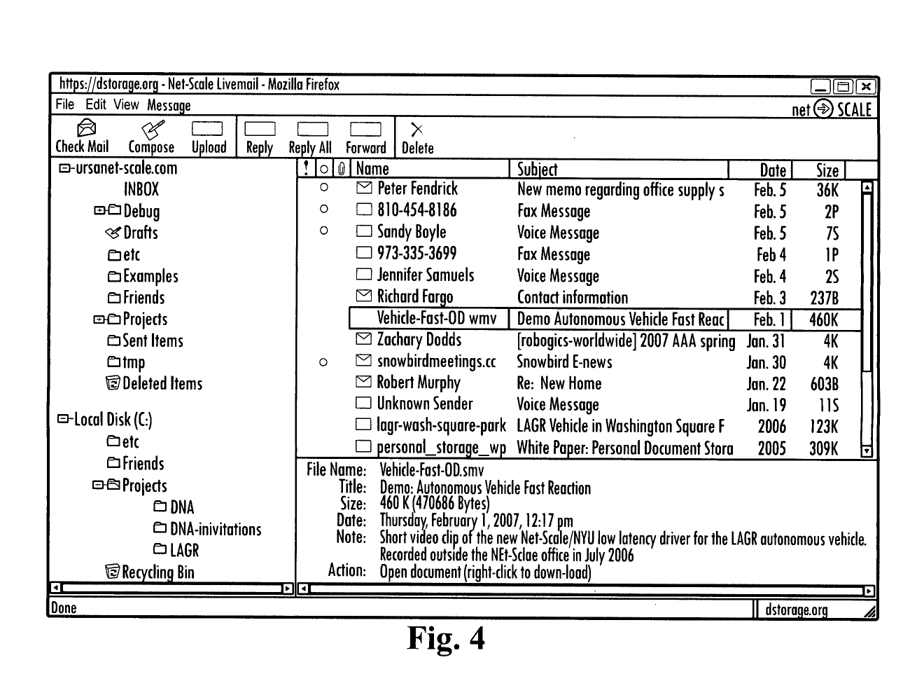

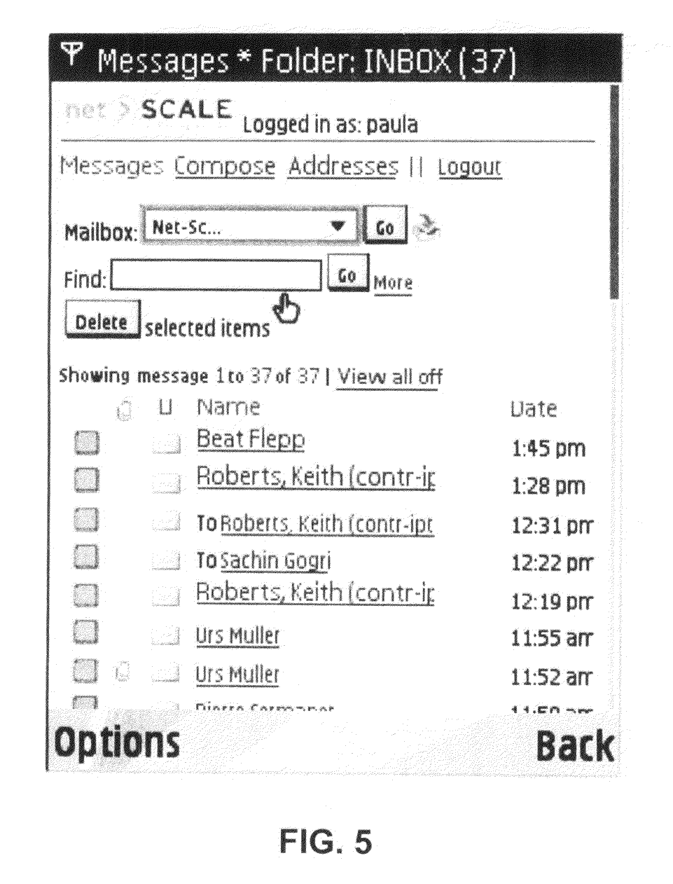

In this embodiment, the Java code, while still started from the original web page 260, runs as a standalone thread in the background. The standalone thread provides an XML interface to the local system, similar to the HTTP/XML interface 270 which the web server provides to the repository 210. This allows the existing JavaScript code to be fully reused for interactions with the local system including the local file system 290. It simplifies the system and guarantees consistency of the user experience between repository and the local system interactions. For example, as shown in FIG. 4, the local file system tree can seamlessly be added to the repository file system tree. FIG. 5 shows a further example wherein a screenshot of a web-based application is executed on a cellular phone, the application accessing a repository on a network as well as locally stored messages.

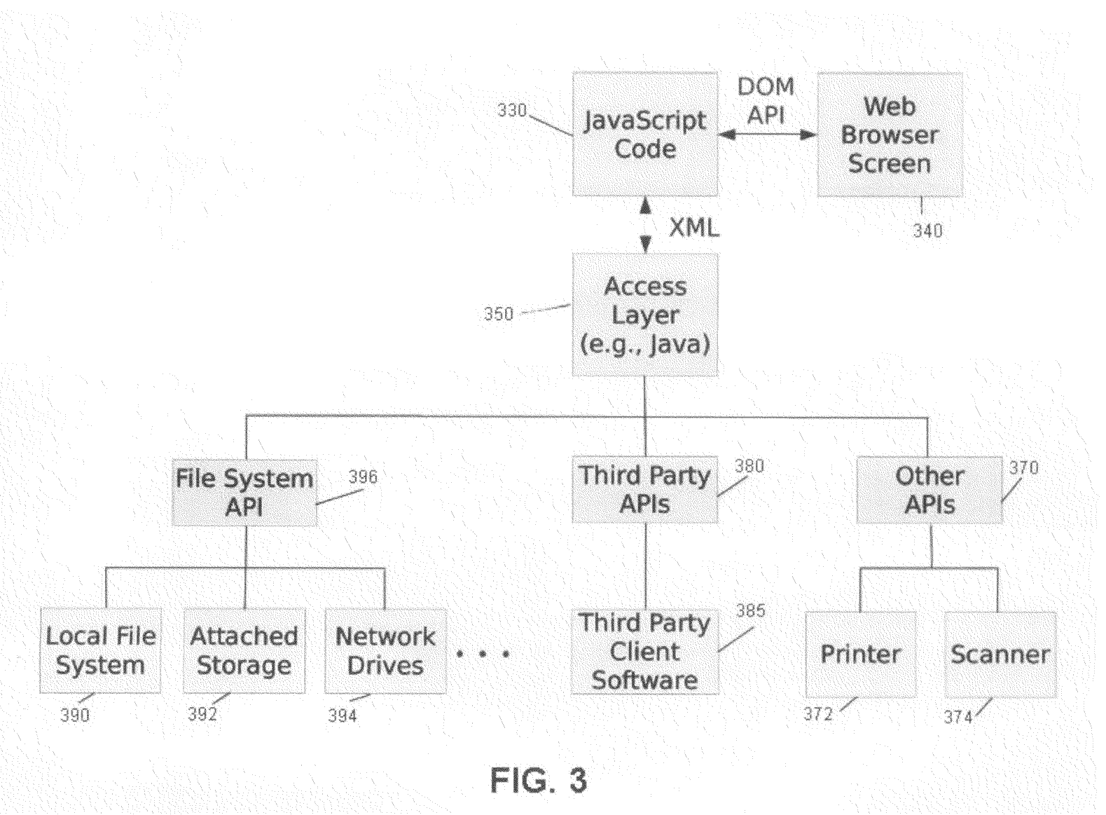

FIG. 3 shows a block diagram of an access layer as used in an embodiment of the invention. In this embodiment, Javascript code 330 or code programmed in another language is used to power an application which is displayed on a web browser screen 340 via an interface such as an interface using the Document Object Model (DOM). The application interacts with an access-layer 350. The access layer 350 is able to accept instructions and code from the application being executed and displayed on the web browser screen 340 in order to access APIs. The access layer 350 accepts a specific set of instructions from the code 330 to interact directly with devices and peripherals such as with a file system of a local host, third party software, or peripherals. It is, of course, within the scope of the invention to provide APIs and an appropriate instruction set so that the access layer 350 can allow an application to access other devices and features of a local host.

FIG. 3 depicts three of the most common APIs including a file system API 396, third party APIs 380, and other APIs 370, such as those for accessing peripherals including but limited to a printer 372 or scanner 374. In more detail, the file system API 396 is typically configured to interact with the local file system 390, attached storage devices 392, and network drives 394. Other types of storage such and file systems including RAM drives, virtual drives, and the like are also contemplated and within the scope of the invention. The third party APIs 380 are typically programmed by other vendors and allow a web-based application to access existing or new software programmed by other vendors. Thus, a third party vendor may provide APIs so that their existing or new software will work with the APIs of the present invention. The motivation for doing so is so that the existing invention can be expanded to include many applications and so that third party vendors can provide the features and benefits of the present application to their software programs. The use of the access layer 350 and APIs 370, 380, and 396 will became clearer in light of the forthcoming paragraphs.

In an embodiment of the invention, low-level device drivers are provided which directly access corresponding hardware devices. Thus, in an embodiment of the invention, direct hardware access is provided. The low-level device drivers typically support direct access to devices such as video adapters, sound cards, network adapters, permanent storage, and the like. For example, a driver for a video adapter can be configured to support a command to display three dimensional sprites. Since video adapters are produced by various manufacturers and various configures are required and are vastly different in, for example, a cellular phone and a computer running Windows, the actual code and process of displaying the sprites may be very different. However, when an application, is executed in the present embodiment of the invention, the application communicates or exchanges data with the access layer of the invention in a predefined manner. The access layer then accesses the hardware resource and sends the appropriate commands or exchanges data with the hardware resource, thus, providing access to the resource from an application. In this example, the video adapter displays the three dimensional sprites as called for by the application when the application exchanges data with the access layer which in turn exchanges data with the video adapter regardless of the hardware or software platform of the computer and web browser. This embodiment of the invention is particularly well suited for cellular phones and personal digital assistants where direct access to the hardware is available. This embodiment is also well suited for use with APIs in operating systems which allow direct access to hardware including DirectX and OpenGL by way of example.

In another embodiment of the invention, the application is executed in a web browser and the web browser is executed on an operating system with a hardware abstraction layer such as WindowsNT, WindowsXP, and Windows Vista, by way of example. The hardware abstraction layer provides an instruction set to access various components of a computer on which the operating system is executed and typically includes instructions for accessing video adapters, sound cards, network adapters, permanent storage, and the like. In such an embodiment of the invention, when an application is executed in the present embodiment of the invention, the application communicates or exchanges data with the access layer of the invention in a predefined manner. The access layer then accesses the hardware abstraction layer and sends the appropriate commands or exchanges data with the hardware abstraction layer which in turn accesses the desired hardware on the local host.

In an embodiment of the invention, the access layer of the interface component resides in an underlying operating system, e.g., a layer in Windows Vista or Ubuntu. In addition to providing a relatively uniform control interface for an application, the access layer need not be downloaded from a server and may be configured to run natively with the operating system. Thus, new operating systems and devices may be developed utilizing the access layer to provide a truly cross platform solution. Users will be less reliant on a specific operating system platform and operating systems may run applications written for embodiments of the invention in a native manner for optimal speed.

It should be understood that the above embodiments of the invention having direct hardware access and access to a hardware abstraction layer may be combined into a single embodiment which may be transparent to the application. The application is executed in the web browser and interacts with at least a resource on the local host via the access layer. APIs within the access layer may be configured to access various hardware resources both directly and through a hardware abstraction layer. The common API scheme allows a single piece of code or function call in an application to be used to access a hardware resource regardless of whether a hardware abstraction layer is implemented between the application and the hardware resource.

In an embodiment of the invention the access layer of the interface component is automatically loaded and executed by the web browser requiring no formal installation by an end user. This may be accomplished, by example, with Java, Javascript, Flash, or other readily available languages which are found in web browsers.

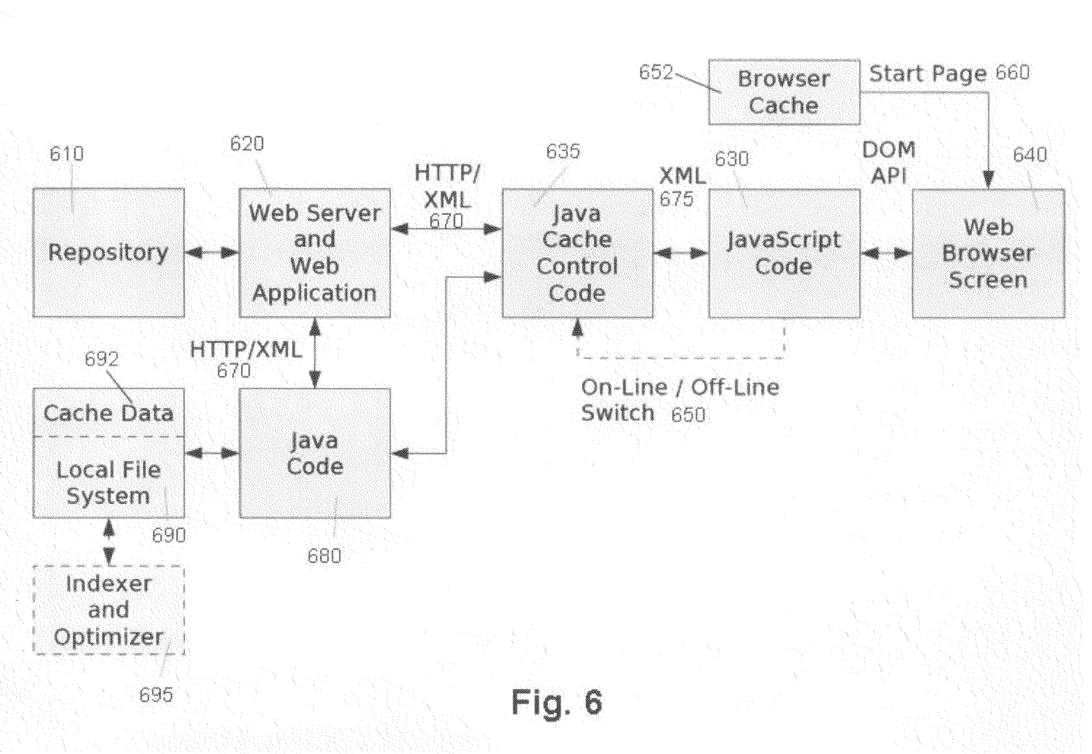

FIG. 6 shows a block diagram of a platform independent method of implementing an embodiment of the invention with an offline mode. To provide an offline mode, additional elements are utilized. A browser cache 652 is used with a web browser. The browser cache comprises data which has been downloaded from a web server 620 or has otherwise been accessed by the browser in the past. In embodiments of the invention, applications are configured to never automatically expire (be deleted) from the browser cache.

The start page 660 of the web page which comprises display of the web application 620 on the web browser screen 640 may be loaded from the network or from the browser cache 652. It is desirable to load the application from the browser cache 652 to preserve network resources and have faster load times. When in an offline state, the application and start page 660 must be loaded from the browser cache 652 because the network, comprising the web server 620 and repository 610 are not available. Further, cache data 692 is provided in the local file system 690. The cache data 692 comprises data such as is found in the repository 610 for accessing while in an offline mode. The cache data 692 may also comprises web cache data and Java control cache data. Such data is stored in the cache data 692 because it may be easily stored separately from the browser data and generally accessed only by the application whereas other locations are shared with the general browser and other caches and may be more susceptible to corruption or data loss.

In the present embodiment, an on-line/off-line switch 650 is provided. The Javascript code 630 becomes aware of the change in state and utilizes the Java cache control code to perform various functions. When going into an offline state, the web application, complete with data comprising the access layer and data such as individual emails are downloaded to the local computer. When returning to an online state, the data such as emails to be sent and new incoming emails is synchronized so that the server and local host comprise the same data. When the local host is subsequently toggled between an online and offline state, the data is further synchronized to ensure that the local host and server have the same data. This is especially useful in environments such as planes where the end user is typically less productive because the user cannot access the network to access the online applications.

In an embodiment of the invention, the APIs are provided to control peripheral devices. In a personal computer, such devices might include mice, keyboards, sound cards, monitors, scanners, printers, and the like. On a personal digital assistant, such devices might include wireless cards, cameras, Bluetooth accessories, and the like. Thus, an application can be configured to access or control such a peripheral device through the access layer. For example, a standard set of APIs may be provided in the access layer to control mice. The APIs will interact with the various operating environments such as a Logitech mouse on a Windows computer or a touch sensitive screen on a PDA to control the position of the pointer. An API need only be programmed once for each operating environment and then application software need only access a “pointer” API, by example, included in embodiments of the invention.

Such embodiments as referred to herein above are provided by way of explanation of the present invention, which is not intended to be limited thereto. In fact, those of ordinary skill in the art may appreciate upon reading the present specification and viewing the present drawings that various modifications and variations can be made thereto.

Although the illustrative embodiment will be generally described in the context of an application program running on a personal computer, those skilled in the art will recognize that the present invention may be implemented in conjunction with operating system programs or with other types of program modules for other types of computers. Furthermore, those skilled in the art will recognize that the present invention may be implemented in a stand-alone or in a distributed computing environment. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The detailed description that precedes is represented largely in terms of processes and symbolic representations of operations by conventional computer components, including a processing unit (a processor), memory storage devices, connected display devices, and input devices. Furthermore, these processes and operations may utilize conventional computer components in a heterogeneous distributed computing environment, including remote file servers, compute servers, and memory storage devices. Each of these conventional distributed computing components is accessible by the processor via a communication network.

The processes and operations performed by the computer include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein are machine operations performed in conjunction with various input provided by a human operator or user that interacts with the computer.

In addition, it should be understood that the programs, processes, methods, etc. described herein are not related or limited to any particular computer or apparatus. Rather, various types of general purpose machines may be used with the program modules constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read-only memory.

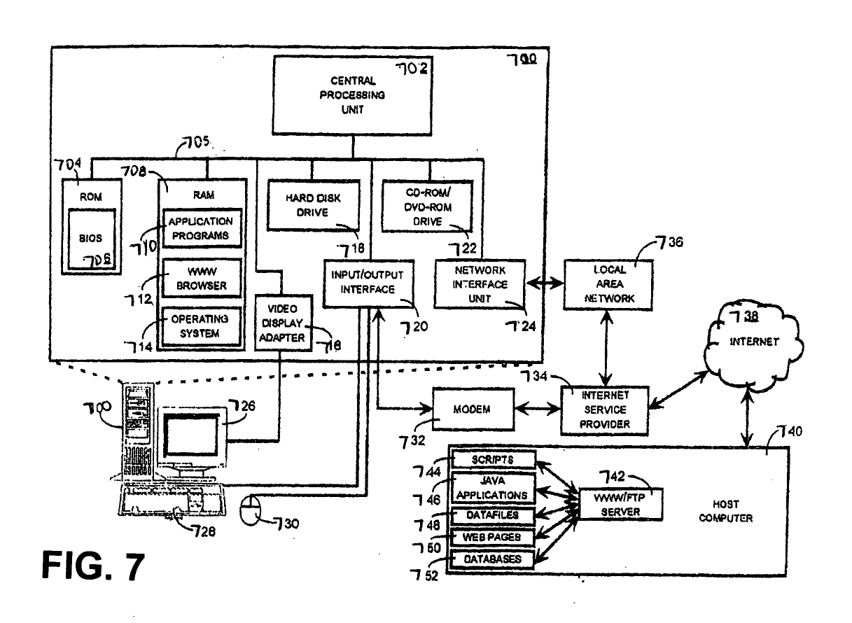

FIG. 7 shows a block diagram of a suitable computing environment in which the invention may be implemented. Referring now to FIG. 7, an illustrative environment for implementing the invention includes a conventional personal computer 700, including a processing unit 702, a system memory, including read only memory (ROM) 704 and random access memory (RAM) 708, and a system bus 705 that couples the system memory to the processing unit 702. The read only memory (ROM) 704 includes a basic input/output system 706 (BIOS), containing the basic routines that help to transfer information between elements within the personal computer 700, such as during start-up. The personal computer 700 further includes a hard disk drive 718 and an optical disk drive 722, e.g., for reading a CD-ROM disk or DVD disk, or to read from or write to other optical media. The drives and their associated computer-readable media provide nonvolatile storage for the personal computer 700. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 708, including an operating system 714 and one or more application programs 710, such as a program for browsing the world-wide-web, such as WWW browser 712. Such program modules may be stored on hard disk drive 718 and loaded into RAM 708 either partially or fully for execution.

A user may enter commands and information into the personal computer 700 through a keyboard 728 and pointing device, such as a mouse 730. Other control input devices (not shown) may include a microphone, joystick, game pad, satellite dish, scanner, or the like. These and other input devices are often connected to the processing unit 700 through an input/output interface 720 that is coupled to the system bus, but may be connected by other interfaces, such as a game port, universal serial bus, or firewire port. A display monitor 726 or other type of display device is also connected to the system bus 705 via an interface, such as a video display adapter 716. In addition to the monitor, personal computers typically include other peripheral output devices (not shown), such as speakers or printers. The personal computer 700 may be capable of displaying a graphical user interface on monitor 726.

The personal computer 700 may operate in a networked environment using logical connections to one or more remote computers, such as a server or host computer 740. The host computer 740 may be a server, a router, a peer device or other common network node, and typically includes many or all of the elements described relative to the personal computer 700. The LAN 736 may be further connected to an internet service provider 734 (“ISP”) for access to the Internet 738. In this manner, WWW browser 712 may connect to host computer 740 through LAN 736, ISP 734, and the Internet 738. Such networking environments are commonplace in offices, enterprise-wide computer networks, intranets and the Internet.

When used in a LAN networking environment, the personal computer 700 is connected to the LAN 736 through a network interface unit 724. When used in a WAN networking environment, the personal computer 700 typically includes a modem 732 or other means for establishing communications through the internet service provider 734 to the Internet. The modem 732, which may be internal or external, is connected to the system bus 705 via the input/output interface 720. It will be appreciated that the network connections shown are illustrative and other means of establishing a communications link between the computers may be used.

The operating system 714 generally controls the operation of the previously discussed personal computer 700, including input/output operations. In the illustrative operating environment, the invention is used in conjunction with Microsoft Corporation's “Windows Vista” operating system and a WWW browser 712, such as Microsoft Corporation's Internet Explorer or Mozilla Corporation's Firefox, operating under this operating system. However, it should be understood that the invention can be implemented for use in other operating systems, such as “WINDOWS XP,” “MacOS”, “Linux”, “Ubuntu”, “PalmOS”, “OS/2”, “SOLARIS” and the like. Likewise, the invention may be implemented for use with other WWW browsers known to those skilled in the art.

Host computer 740 is also connected to the Internet 738, and may contain components similar to those, contained in personal computer 700 described above. Additionally, host computer 740 may execute an application program for receiving requests for WWW pages, and for serving such pages to the requestor, such as WWW server 742. According to an embodiment of the present invention, WWW server 742 may receive requests for WWW pages 750 or other documents from WWW browser 712. In response to these requests, WWW server 742 may transmit WWW pages 750 comprising hyper-text markup language (“HTML”) or other markup language files, such as active server pages, to WWW browser 712. Likewise, WWW server 742 may also transmit requested data files 748, such as graphical images or text information, to WWW browser 712. WWW server may also execute scripts 744, such as PHP, CGI or PERL scripts, to dynamically produce WWW pages 750 for transmission to WWW browser 712. WWW server 742 may also transmit scripts 744, such as a script written in JavaScript, to WWW browser 712 for execution. Similarly, WWW server 742 may transmit programs written in the Java programming language, developed by Sun Microsystems, Inc., to WWW browser 712 for execution. As will be described in more detail below, aspects of the present invention may be embodied in application programs executed by host computer 742, such as scripts 744, or may be embodied in application programs executed by computer 700, such as Java applications 746. Those skilled in the art will also appreciate that aspects of the invention may also be embodied in a stand-alone application program.

We claim:

1. A method for accessing a resource on a local host comprising the steps of:
executing an application, said application configured to exchange data with a server;
exchanging data between said application and an access layer;
exchanging data between said access layer and said at least one resource on said local host; and
providing hardware access of said at least one resource on said local host to said application executed in said web environment.

2. The method of claim 1 wherein said hardware access is direct hardware access.

3. The method of claim 2 wherein said hardware access is through a hardware abstraction layer.

4. The method of claim 1 wherein said local host is a mobile phone.

5. The method of claim 1 wherein said application code is executable when said local host is offline.

6. The method of claim 5 further comprising data synchronization triggered by toggling said local host between an offline and online state.

7. The method of claim 1 wherein said at least one resource is a file system.

8. The method of claim 7 wherein said file system consists of data selected from the group consisting of repositories, directories, mail servers, and databases.

9. The method of claim 1 wherein said at least one resource is a peripheral device on a computer.

10. The method of claim 1 wherein said interface component further comprises user interface templates for use with said application code.

11. The method of claim 1 wherein said application code further comprises an automated installation process.

12. The method of claim 1 wherein said application code comprises Java.

13. An interface component comprising:
an access layer for hardware access to at least one resource of a local host;
application code executable in a web browser allowing interaction with said at least one resource of said local host via said access layer.

14. The interface component of claim 13 wherein said hardware access is direct hardware access.

15. The interface component of claim 13 wherein said hardware access is through a hardware abstraction layer.

16. The interface component of claim 13 wherein said interface component is connected to a web server.

17. The interface component of claim 13 wherein said application code is executable when said local host is offline.

18. The interface component of claim 17 further comprising data synchronization triggered by toggling said local host between an offline and online state.

19. The interface component of claim 13 wherein said at least one resource is a file system.

20. The interface component of claim 19 wherein said file system consists of data selected from the group consisting of repositories, directories, mail servers, and databases.

21. The interface component of claim 13 wherein said at least one resource is a peripheral device on a computer.

22. The interface component of claim 13 wherein said interface component further comprises user interface templates for use with said application code.

23. The interface component of claim 13 wherein said application code further comprises an automated installation process.

24. The interface component of claim 13 wherein said application code comprises Java.

25. The interface component of claim 13 wherein said local host is a hand held device.
